(19) United States
(12) Patent Application Publication
(10) Pub. No.: US 2010/0322041 A1
(43) Pub. Date: Dec. 23, 2010

(54) WATCH COMPRISING A MIDDLE MACHINED IN A BLOCK OF EXTRA-HARD MATERIAL

(75) Inventor: Guy Semon, Neuchatel (CH)

Correspondence Address: PEARNE & GORDON LLP, 1801 EAST 9TH STREET, SUITE 1200, CLEVELAND, OH, 44114-3108, US

(73) Assignee: ATTO HOLDING S.à.r.I., Luxembourg (LU)

(21) Appl. No.: 12/832,418

(22) Filed: Jul. 8, 2010

Related U.S. Application Data
(63) Continuation of application No. PCT/IB2009/000027, filed on Jan. 9, 2009.

(30) Foreign Application Priority Data
Jan. 11, 2008 (FR) 08/50167

(51) Int. Cl. G04B 37/22

(52) U.S. Cl. 368/280

(57) ABSTRACT

The invention relates to a watch including a timepiece mechanism and a casing particularly including the glass (2) and the middle (4). The middle (4) and the glass form a single piece machined in a block of a transparent mineral material.

### RELATED APPLICATIONS

This application is a continuation of International Application PCT/IB2008/000027 filed on Jan. 9, 2009, the contents whereof being incorporated by reference. It claims priority of French Patent Application FR2008/50167, filed on Jan. 11, 2008, the contents whereof being incorporated by reference

### TECHNICAL FIELD

The present invention concerns the field of watchmaking and more precisely the casing elements of a watch or the functional parts of a timepiece movement, whether mechanical or quartz. It concerns in particular the production of complex monolithic watch components made of extra-hard materials for applications to casing functions and mechanical functions with physical-chemical improvement of the contact interfaces.

The jeweler's art and the watchmaking industry have always cohabited. Many watches or clocks are cased with natural gems or synthetic stones being mounted. The present invention reverses the general uses by making functional an extra-hard monolithic material by implementing it in a variety of static or dynamic mechanical functions. We will describe the way of making all or part of a watch casing or movement by monolithic assemblies achieved in an extra-hard material, colored or not, transparent or opaque. The invention constitutes an original development making it possible to do without the usual mounted elements called “stones” or “sapphires” used for pivoting functions. Finally, an advantageous extension of the invention will allow the physical-chemical and/or optical properties of the contact interfaces to be adapted by means of thing layer depositions.

It is known in the state of the art to make a watch casing constituted by a box composed of a supporting frame called middle (4) generally made of metal or ceramics, of a glass part called glass (2) usually of sapphire and of a bottom (3) made of metal or being transparent made of sapphire.

The metallic parts are generally made by machining, molding or sintering operations, complemented by different forming and/or finishing manufacturing operations. It is of recognized use for all the casing components, middle (4), bottom (3) etc. should exhibit considerable physical-chemical properties such as for example: good resilience and toughness, excellent hardness, and resistance to ultra-violet. Therefore, horological elements are classically made of a metallic and sometimes ceramic material.

Is known in the state of the art a watch described in European patent application EP1617306, comprising a timepiece mechanism and a case bearing a glass and a middle. The middle is machined in an extra-hard material.

One also knows the patent EP0131267 describing a mechanical watch whose constituting elements are mounted inside a support frame constituted of a layering of transparent sheets of corundum, spinel or quartz, of which some have cut-outs that enable said elements to be accommodated.

Other documents such as the British patents GB2062909 and GB660365 describe watches having several dissociated components.

These solutions known in the state of the art represent a considerable number of parts with variable and different physical-chemical properties and especially a multiplication of the connection interfaces, themselves causing geometry, dimension or position uncertainties.

Consequently, the existing solutions are not optimal from a mechanical point of view and do not allow the entire timepiece movement to be made visible through its casing nor the latter to be integrated in a monolithic crystalline structure, or even some parts to be made in this same structure.

In order to remedy these drawbacks, the present invention according to its most general embodiment concerns the assembly in the form of machined monoliths, mineral or synthetic, conceived from metallic oxides, glass or crystals, of usually disjointed elements assembled by mechanical means. Thus, a watch ordinarily including a timepiece mechanism and a casing formed of at least a middle, a glass, a bottom, a plate and several bridges could comprise at least one of the following combinations:

| | Middle | Glass | Bottom | Plate | Bridges |
|---|---|---|---|---|---|
| Middle | 0 | 1 | 1 | 1 | 0 |
| Glass | 1 | 0 | 1 | 1 | 1 |
| Bottom | 1 | 1 | 0 | 1 | 1 |
| Plate | 1 | 1 | 1 | 0 | 0 |
| Bridges | 0 | 1 | 1 | 0 | 0 |

Thus, the material of an assembly combined of two components, at least, is identical to the extra-hard, transparent or not material constituting one of the two components in order to make the timepiece movement either visible to the user or in order to benefit from the physical-chemical properties of the materials and/or of the depositions made on the inner or outer surfaces.

According to an advantageous embodiment, the middle and the glass form a monolithic piece with symmetry or other axes generated in a block of compact and solid transparent material such as a ceramic or any other vitrified metallic oxide, or even the assembly of different materials by molecular brazing.

According to another embodiment, the plate and/or the bridges are also machined in a block of extra-hard, transparent or not material.

According to a particular embodiment, the middle, the plate and the glass form, by combination of at least two components, a single monolithic piece made in a block of extra-hard, transparent or not, solid material.

Advantageously, at least some of the components of the timepiece movement (plate, bridges, barrel drum . . . ) are machined in a block of extra-hard solid material, transparent or not. According to a particular embodiment, at least part of the contact connections between parts such as pivots, slide, ball joint, . . . are made by direct machining in the supporting elements such as plate or bridges formed in a block of extra-hard, transparent or not material. The direct advantage is a reduction of the number of parts as well as a reduction of the functional dimensioning constraints whilst improving solid friction conditions.

The materials used are characterized by their non-machinability by means of standard manufacturing technologies or also by the prohibitive price or non-industrial character of the few machining operations encountered, such as for example ultrasonic boring . . . .

The materials used are characterized by their crystalline matrix, obtained by means of at least one oxide, of metal or rare earths to achieve a more or less dense coloration ranging from perfect transparency to total opacity. Preferably, said extra-hard transparent material is taken, without this being exhaustive, from one of the following families:
Mixed oxides
Doped oxides
Spinel
Perovskytes
ZnO
ZrO2
Al2O3
SnO
Hydroxyapatite (HAP)
Ceramic nano-materials, charged or not

and more particularly ceramics obtained from the following compounds: alum earth, silicon nitride, mullite, zirconia, aluminum nitride, cordierite, magnesium oxide, boron nitride, steatite, silicon carbide, perovskites.

Advantageously, the material or materials used result from a chemical formulation enabling an appreciable improvement of the mechanical properties, notably as concerns the physics of the interfaces (hardness, tribology, . . . ). Thus, the invention can advantageously be improved by implementing surface depositions, notably by “sol-gel” processes using nano-particles incorporated in different organic and inorganic matrices with the aim of obtaining thick layers ranging from some tens of nanometers to some micrometers, homogenous, without fissuring and having good optical properties. These layers can be deposited, without this being exhaustive, for example by means of the following methods: tempering, whirl coating, spin coating, dip coating, screen printing, spray pyrolysis. The deposition of colloid metallic materials (Ag, Au, Pd, Cu . . . ) in sol precursors of the type SiO2, TiO2, ZrO2, SiO2—PbO, . . . , with thermal treatments and densification, will make it possible to achieve colors—yellow, blue, red, green, grey, brown—having an excellent resistance to abrasion or to UV irradiation as well as a great chemical stability. In the same manner, using a silica sol with for example titanium or silicon oxide pigments will enable shades of white to be achieved whilst affording excellent mechanical properties. Advantageously, using such depositions will enable antireflection coatings or antistatic or optical properties such as photo-chromatic properties to be obtained.

An extension of the invention will be relevant by using extra-hard materials, transparent or not, coupled with metallic materials following the known method of reactive or non-reactive brazing with or without metallization. The deposited layers will follow the classical model ceramic-tungsten or moly-manganese-nickel-gold. The result will always be a monolith assembling in homogenous and inseparable fashion at least two components usually disjointed and assembled by means of mechanical connections (for example glass-middle) or metallic zone in a sapphire plate enabling a boring-drilling.

The invention will be better understood by reading the following description, referring to the attached drawings wherein:

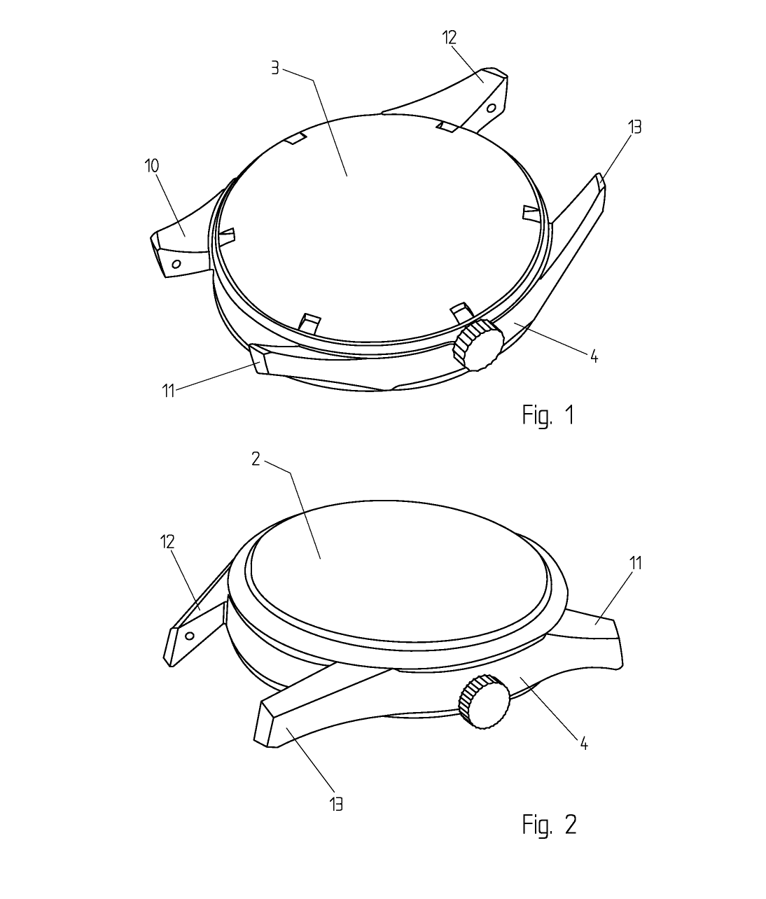

FIG. 1 represents a perspective view from below of a watch according to a first embodiment of the present invention;

FIG. 2 represents a perspective view from above of a watch according to a first embodiment of the present invention;

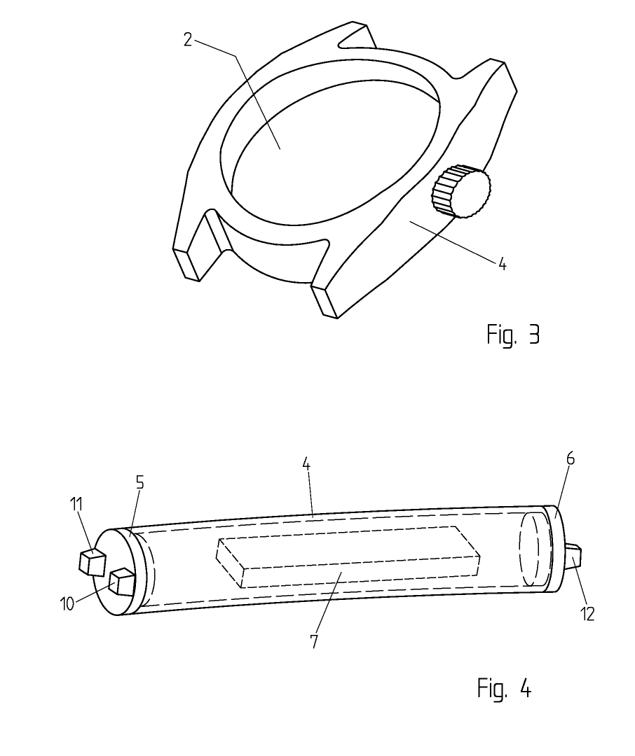

FIG. 3 represents a perspective view from above of a watch according to a second embodiment of the present invention;

FIG. 4 represents a perspective view from above of a watch according to a third embodiment of the present invention.

The watch represented in FIGS. 1 and 2 is constituted by a middle (4) delimiting an inner volume roughly cylindrical, having horns (10 to 13); this part is made of a block of extra-hard material such as a block of natural crystal or another extra-hard transparent material. This crystal block is shaped by machining and is closed by two complementary parts, namely a bottom (3) and a glass (2), also made in a block of extra-hard material and preferably in the same material as the middle (4).

According to a variant embodiment, the movement comprises a plate also made from a block of extra-hard material, which can be an inner extension of the middle (4). This embodiment makes it possible to avoid having to use bearings for the pivots of moving parts.

The watch represented in FIG. 3 is constituted by a middle (4) extended by a bottom or by a glass (2) formed in a single block of extra-hard material unique for the middle on the one hand and for the bottom or the glass on the other hand.

The watch represented in FIG. 4 corresponds to a first embodiment. It presents a body machined in a block of natural or synthetic crystal having a ring-shaped middle (4) closed by two axis-symmetrical surfaces (5, 6). The middle (4) is formed by extrusion of a form on an axis. The middle is mono-block and serves as bottom and glass. It is closed by two parietal surfaces (5, 6) perpendicular to the axis of symmetry.

The tube-shaped middle (4) encloses a movement (7) having a plate that is optionally also made of the same extra-hard material.

Generating monolithic assemblies is achieved by machining techniques by abrasion or sintering.

The first method for obtaining the assemblies is a machining by abrasion using a very high-frequency spindle turning at 60,000 turns per minute and beyond. We develop our own tools composed of diamond grains having a controlled grading and interconnected by means of a ceramic binder. The machining quality makes the material practically transparent to the eye. The final finish is achieved by polishing by means of mobile buffers that make a diamond dip-coat circulate through viscosity. We can perform all the machining operations, with the exception of the threading following a 5-axis tool dynamics. The technique thus applies to warped surfaces as well as to finishing reentrant angles eminently important in the watchmaking industry.

The second method for generating the assemblies, reserved for the largest series, implements a sintering technique by “gel casting” (molding the material in liquid phase) which is considerably more advantageous by comparison with “dry sintering” techniques where porosity problems are difficult to solve. Using a viscous phase makes it possible to generate complex shapes whose limits are set by the molds.

1. A watch comprising a timepiece mechanism and a casing, said casing including a glass and a middle, said middle and said glass forming a monolithic piece machined in a block of extra-hard material.

2. The watch of claim 1, said material being transparent.

3. The watch of claim 1, characterized in that the middle and the glass form a monolithic piece, with symmetry or other axes or planes, machined in a block of extra-hard material.

4. The watch of claim 1, comprising a plate and/or bridges are also machined in a block of extra-hard material.

5. The watch of claim 1, wherein said middle, a plate and said glass form a monolithic piece machined in a block of extra-hard transparent material.

6. The watch of claim 1, characterized in that at least some of the components of the watch movement are generated by means of extra-hard materials.

7. The watch of claim 1, comprising pivot connections machined in said plate and/or in said bridges formed in a block of extra-hard material.

8. The watch of claim 1, said extra-hard material being formed by a natural gem, a synthetic gem or after vitrification of a vitrifiable oxide.

9. The watch of claim 1, said transparent material being doped by means of at least one oxide, metal or rare earth to achieve the desired chromatic density.
